(19) United States
(12) Patent Application Publication
(10) Pub. No.: US 2002/0109064 A1
(43) Pub. Date: Aug. 15, 2002

(54) Height adjustable picture hanger

(76) Inventor: Michael Zuller, Great Neck, NY (US)

Correspondence Address: BIERMAN MUSERLIAN AND LUCAS, 600 THIRD AVENUE, NEW YORK, NY, 10016

(21) Appl. No.: 09/783,267

(22) Filed: Feb. 12, 2001

(51) Int. Cl. B60R 1/02

(52) U.S. Cl. 248/477; 248/476; 248/297.21; 248/495

(57) ABSTRACT

A picture hanger with a height adjustable hook allows the height of the picture to be adjusted from time to time. The hanger uses a back plate on which two opposed crenelated tracks are positioned. Moving in the crenelated tracks are two spring biased crenelated cars. The hook is attached to the crenelated cars. Additional stability is provided to the cars by either a traveling plate which moves between the tracks and the back plate or a traveling block which is slidably mounted in a channel in the back plate and on a rod positioned in the channel of the back plate.

### BACKGROUND OF INVENTION 1. Technical Field

The present invention relates to wall mounted picture hangers and, more specifically, to wall mounted picture hanger with height adjustable hooks.

2. Related Art

Wall mounted adjustable picture and mirror hangers are old. Generally, such hangers can be divided between those that have one unit fixed to the wall and a second unit fixed to the back of the picture and those that have a first unit fixed to the wall and a second adjustable unit movably mounted on the first unit. In the first type of hangers, the second unit travels on and is supported by the first unit, see for example, U.S. Pat. Nos. 1,432,206; 2,569,622; 2,943,831; 2,975,994; 3,285,549; 4,228,982; 5,878,987; 6,032,915; and 6,095,479. In the second type of picture hanger, the second unit has a hook from which the picture hangs by means of wire conventionally attached to the back of the picture. This second type of hanger is exemplified in U.S. Pat. Nos. 1,182,702; 4,892,284; and 6,003,825.

The second type of picture hanger is preferable over the first type because most pictures are mounted in frame and have wire attached to the back of the frame for hanging the picture from the wall. Thus, only one step is necessary to employ the hanger, i.e. attach the hanger to the wall.

There is a need for a simple height adjustable picture hanger which is easy to attach to the wall and has a hook which is adjustable in height and from which a picture can be conventionally hung by means of wire.

### SUMMARY OF INVENTION

A height adjustable picture hanger has now been discovered that is easy to attach to the wall and has a vertically adjustable hook. The present invention is employed for both pictures and mirrors which have a wire or hook on the back to which the hook of the present invention is attached.

It has been discovered that a simple height adjustable picture hanger can be made by employing two opposed vertical oriented crenelated tracks which are affixed to the wall in conjunction with a hook that is attached to two biased, crenelated cars which travel in the crenelated tracks.

By moving the cars in the tracks, the hook can move vertically, thereby providing height adjustment for the picture or mirror. The use of a crenelate track with crenelate cars provide stability to the picture hanger.

Broadly, the present invention is a height adjustable picture hanger comprising two opposed, vertically oriented, crenelated tracks which are affixed to the wall; two opposed spring biased cars positioned between the tracks, each car has a crenelated surface that mates with one of the crenelated tracks, the cars being movable along the tracks; and a hook attached to said cars and movable therewith.

The cars each have a crenelated surface that mates with a corresponding crenelated track.

The term “crenelated” as used herein means a straight surface with evenly spaced and dimensioned teeth. The tracks have a plurality of such teeth while each car has at least two and preferably three or four teeth.

Preferably, in order to provide stability to the present invention, the hanger employs a back plate which is attachable to a wall; a channel which is vertically oriented and centrally located in the back plate, both ends of the channel being closed; a rod which is centrally located in said channel and extended between both ends of the channel; and a traveling block which is positioned in the channel and having a hole therethrough in which the rod passes, the block is vertically movable on said rod. The block is attached to the hook and the cars while the tracks are attached to the back plate and positioned on either side of the channel.

Alternatively, stability is provided to the present invention by employing a back plate which is attached to the wall and on which the tracks are mounted, the tracks are spaced away from the back plate thereby providing a space therebetween; and a traveling plate attached to the cars and the hook and positioned between the tracks and back plate in said space.

The traveling plate acts like the channel, rod and traveling block to provide stability to the hanger.

Preferably, the picture hanger of the present invention has four holes positioned around the back plate through which a screw can pass so as to affix the hanger to the wall.

More preferably, the picture hanger of the present invention has a bubble gauge. The bubble gauge affixes to the back plate and allows the user to insure that the hanger is horizontally level.

In order to affix the traveling block or the traveling plate to the cars and the hook, a frame is affixed to the traveling block/traveling plate and positioned between the tracks. The two cars are movably mounted in the frame and the hook is attached to said frame.

In a preferred embodiment, the present invention is a wall mounted picture hanger having a height adjustable hook which comprises a back plate attachable to a wall; a channel is vertically oriented and centrally located in the back plate, both ends of the channel are closed; a rod is centrally located in the channel and extends between both ends of the channel; two opposed, vertically oriented, crenelated tracks are mounted in the back plate on either side of the channel; a traveling block is positioned in the channel and has a hole therethrough in which said rod passes, said block is vertically movable on said rod; two spring biased cars are affixed to the block and positioned between the crenelated tracks, each of the cars having a crenelated portion which mates with one of the crenelated tracks; and a hook is affixed to the block for hanging a picture therefrom.

In another preferred embodiment, the wall mounted picture hanger of the present invention comprises a back plate attachable to a wall; two opposed, vertically oriented, crenelated tracks mounted on said back plate and spaced away from said back plate so as to create a space between said back plate and said tracks; a traveling plate positioned between said back plate and said tracks in said space and vertically movable therein; two, spring biased cars affixed to said traveling plate and positioned between said crenelated tracks, each of said cars having a crenelated portion which mates with one of said crenelated tracks; and a hook affixed to said traveling plate for hanging a picture therefrom.

These and other aspects of the present invention may be more fully understood by reference to the following drawings and the detailed description of the invention.

### BRIEF DESCRIPTION OF THE DRAWINGS

FIG. 1 illustrates a front view of one embodiment of the picture hanger of the present invention;

FIG. 2 illustrates a top view of the hanger taken along line 2-2 of FIG. 1;

FIG. 3 illustrates a front view of the back plate with the channel, the rod, the gauge and the two crenelated tracks;

FIG. 4 illustrates a top view of the hook, traveling block, two crenelated cars and frame;

FIG. 5 illustrates the frame;

FIG. 6 illustrates the two crenelated cars with coil springs therebetween;

FIG. 7 illustrates the hook;

FIG. 8 illustrates a front view of another embodiment of the picture hanger of the present invention;

FIG. 9 illustrates a top view of the hanger taken along lines 9-9 of FIG. 8; and

FIG. 10 illustrates a top view of another embodiment of the hanger of FIG. 8.

### DETAILED DESCRIPTION OF INVENTION

In FIG. 1, picture hanger 10 has a back plate 12 which has four holes 14 in the frame for attachment of plate 12 to the wall. Plate 12 has bubble gauge 16 for horizontally orienting picture hanger 10. In the center of plate 12 is located channel 18 in which rod 20 resides. Bordered on either side of channel 18 are crenelated or toothed tracks 22. Residing in and movable in channel 18 is hanger element 30.

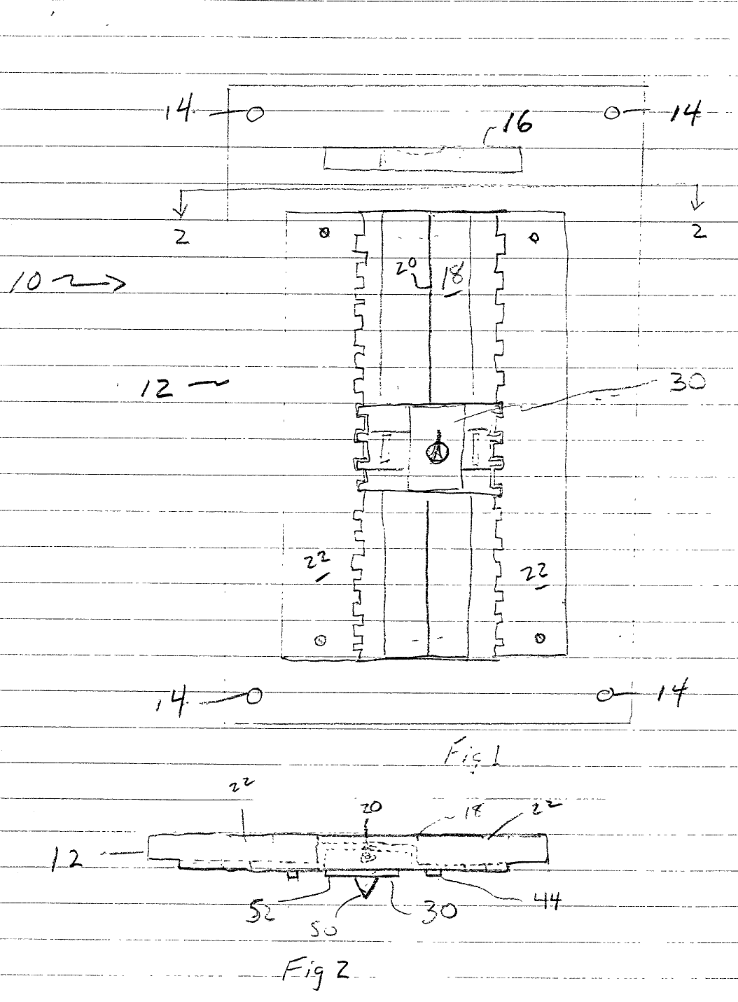

FIG. 2 is a top view taken along lines 2-2 of FIG. 1.

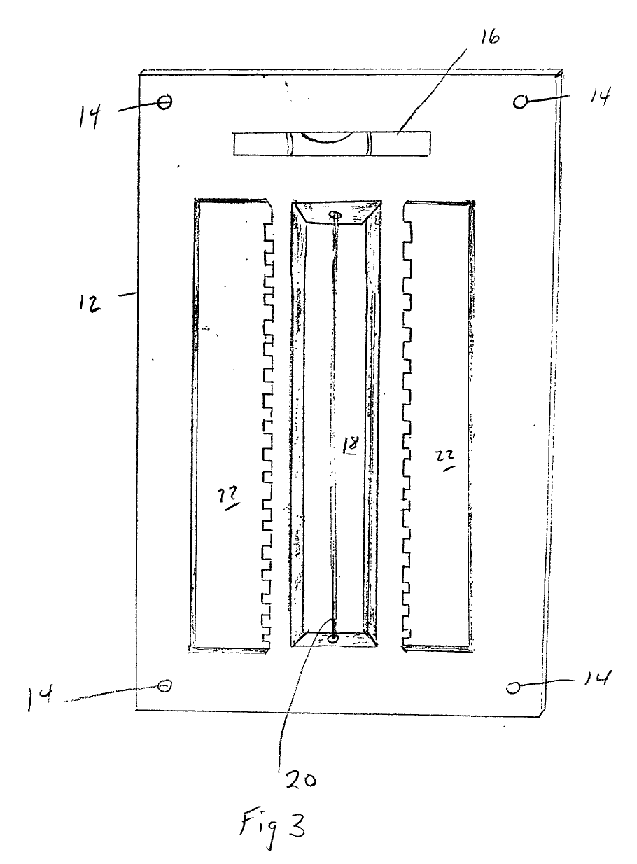

FIG. 3 illustrates a front view of the frame 12 without hanging unit 30 therein.

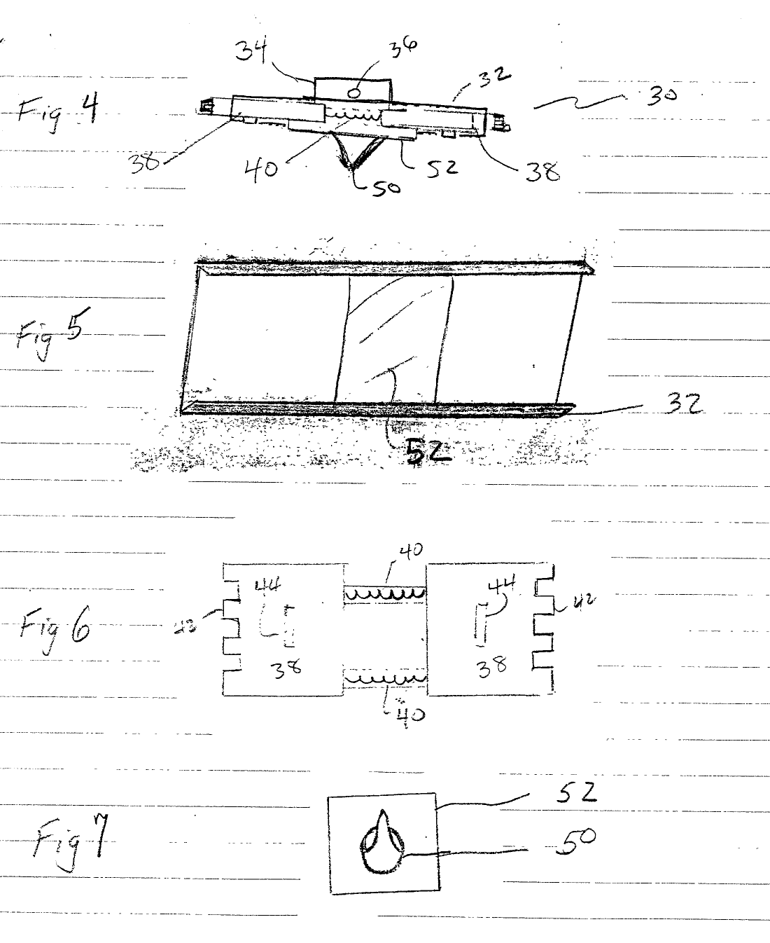

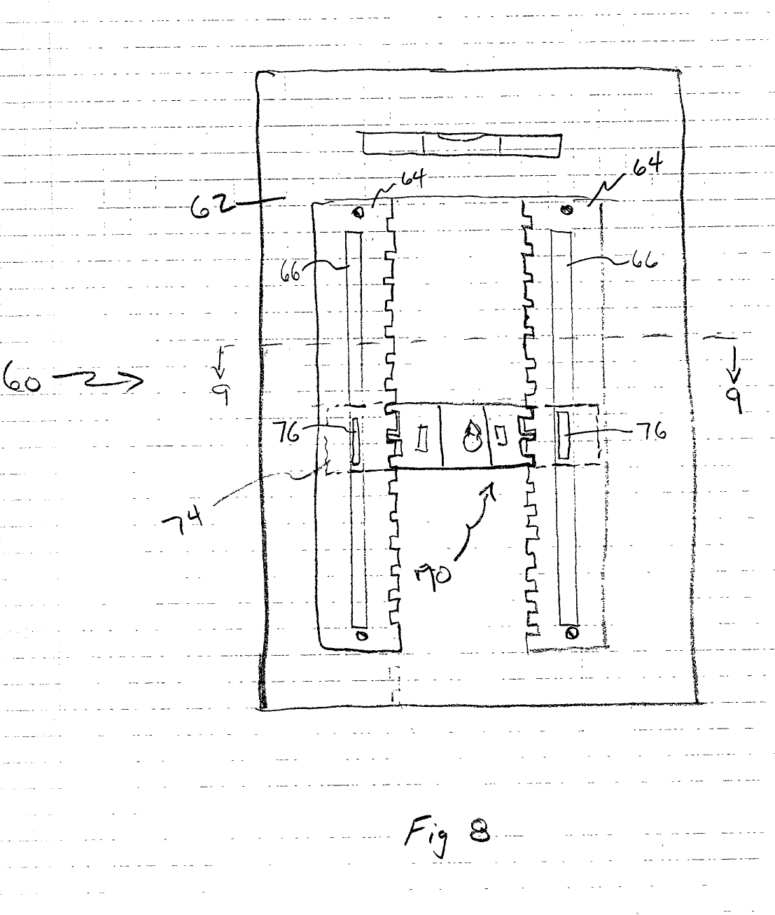

FIGS. 4 through 7 illustrate the various elements of hanging unit 30. FIG. 4 is a top view of hanging unit 30 while FIGS. 5 through 7 illustrate the different parts of hanging unit 30.

Hanging unit 30 comprises frame 32 with traveling block 34 that travels in track 18 and has hole 36 for accommodating rod 20. Inside of frame 32 resides two spring biased crenelated cars 38 which are forced outward by coil springs 40. Each one of cars 38 has teeth 42 which match the teeth in tracks 22. Cars 38 have finger grips 44 which allow the user to compress springs 40 and disengage teeth 42 from the teeth of tracks 22, thereby allowing the vertical movement of hanging unit 30. Positioned on the outside of finger elements 38 but held by track 32 is hook 50. Hook 50 is attached to front plate 52 of frame 32 while traveling block 34 is attached to the back of frame 32.

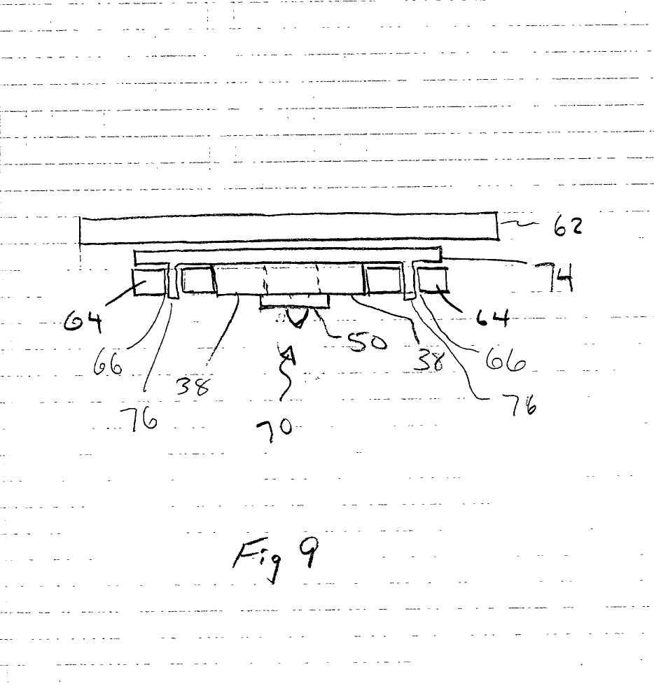

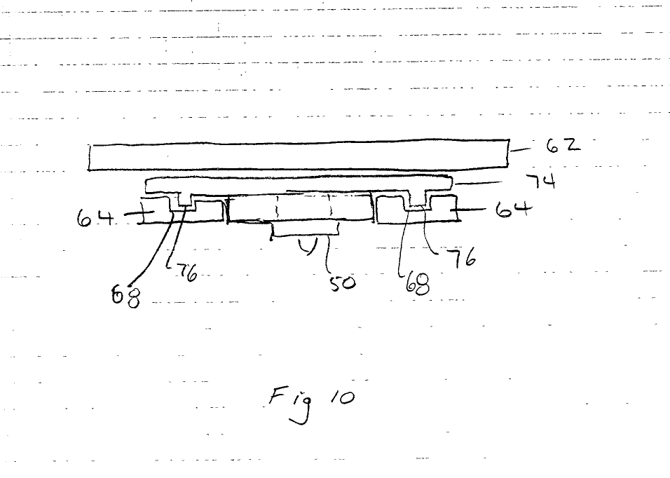

FIGS. 8 and 9 illustrate picture hanger 60 with back plate 62 and tracks 64 positioned away from the face of plate 62 so that traveling plate 74 of hanging unit 70 can move therebetween. Each track 64 has longitudinal holes 66 in which tabs 76 travel. Tabs 76 are affixed to plate 74. Tabs 76 and holes 66 help maintain alignment between plate 74 and tracks 64. Longitudinal guide holes 66 extend through tracks 64, however, they need not extend completely through tracks 64 but can be channels 68 as shown in FIG. 10.

Tracks 64 are attached at either end to back plate 62 as shown.

As will be appreciated, traveling plate 74 and frame 32 can be molded to form one piece.

Suitably, the hanger of the present invention is small enough to fit behind and be hidden by the picture. Suitably, the back plate and, thus, the overall dimensions of the unit, are about four (4) inches in height, about three (3) inches in width, and no more than one (1) inch thick. Since both the size and weight of pictures and mirrors can vary, the dimensions of the hanger of the present invention can vary.

It will be understood that the claims are intended to cover all changes and modifications of the preferred embodiments of the invention herein chosen for the purpose of illustration which do not constitute a departure from the spirit and scope of the invention.

What is claimed is:

1. A wall mounted picture hanger having a height adjustable hook comprising:
two opposed vertically oriented crenelated tracks affixable to a wall;
two opposed spring biased cars positioned between said tracks, each car having a crenelated surface that mates with one of said crenelated tracks, said cars movable in said tracks; and
a hook affixed to said two cars for movement therewith.

2. The hanger of claim 1 further comprising:
a back plate attachable to said wall;
a channel vertically oriented and centrally located in said back plate, both ends of said channel being closed;
a rod centrally located in said channel and extended between both ends of said channel;
said tracks mounted on said back plate and positioned on either side of said channel;
a traveling block positioned in said channel and having a hole therethrough in which said rod passes, said block vertically movable in said rod; and
said hook and said cars affixed to said traveling block.

3. The picture hanger of claim 2 wherein said back plate has four holes positioned around said plate through which a screw can pass so as to affix said hanger to said wall.

4. The picture hanger of claim 2 further comprising a bubble gauge, said bubble gauge affixed to said back plate.

5. The picture hanger of claim 2 further comprising a frame affixed to said traveling block and positioned between said tracks, said two cars movably mounted in said frame and said hook attached to said frame.

6. The hanger of claim 1 further comprising:
a traveling plate affixed to said hook and to said cars,
said two tracks positioned away from said wall so as to provide a space between said wall and said tracks,
said traveling plate positioned in said space between said tracks and said wall.

7. The hanger of claim 1 further comprising:
a back plate affixable to said wall, said tracks affixed to said back plate and spaced away from said back plate so as to provide a space between said tracks and said back plate; and
a traveling plate affixed to said hook and to said cars, said traveling plate positioned in said space between said back plate and said tracks.

8. The picture hanger of claim 7 wherein said back plate has four holes positioned around said plate through which a screw can pass so as to affix said hanger to said wall.

9. The picture hanger of claim 7 further comprising a bubble gauge, said bubble gauge affixed to said back plate.

10. The picture hanger of claim 7 further comprising a frame affixed to said traveling plate and positioned between said tracks, said two cars movably mounted in said frame and said hook attached to said frame.

11. A wall mounted picture hanger having a height adjustable hook comprising:
a back plate attachable to a wall;
a channel vertically oriented and centrally located in said back plate, both ends of said channel are closed;
a rod centrally located in said channel and extend between both ends of said channel;
two opposed, vertically oriented, crenelated tracks mounted on said back plate on either side of said channel;
a traveling block positioned in said channel and having a hole therethrough in which said rod passes, said block vertically movable on said rod;
two spring biased cars affixed to said block, and positioned between said crenelated tracks, each of said cars having a crenelated portion which mates with one of said crenelated tracks; and
a hook affixed to said block for hanging a picture therefrom.

12. The picture hanger of claim 11 wherein said back plate has four holes positioned around said plate through which a screw can pass so as to affix said hanger to said wall.

13. The picture hanger of claim 11 further comprising a bubble gauge, said bubble gauge affixed to said back plate.

14. The picture hanger of claim 11 further comprising a frame affixed to said traveling block and positioned between said tracks, said two cars movably mounted in said frame and said hook attached to said frame.

15. A wall mounted picture hanger having a height adjustable hook comprising:
a back plate attachable to a wall;
two opposed, vertically oriented, crenelated tracks mounted on said back plate and spaced away from said back plate so as to provide a space between said back plate and said tracks;
two spring biased cars affixed to said traveling plate and positioned between said crenelated tracks, each of said cars having a crenelated portion which mates with one of said crenelated tracks; and
a hook affixed to said block for hanging a picture therefrom.

16. The picture hanger of claim 15 wherein said back plate has four holes positioned around said plate through which a screw can pass so as to affix said hanger to said wall.

17. The picture hanger of claim 15 further comprising a bubble gauge, said bubble gauge affixed to said back plate.

18. The picture hanger of claim 15 further comprising a frame affixed to said traveling plate and positioned between said tracks, said two cars movably mounted in said frame and said hook attached to said frame.
